(19) United States
(12) Patent Application Publication
(10) Pub. No.: US 2016/0086513 A1
(43) Pub. Date: Mar. 24, 2016

(54) SERVER APPARATUS, DATA INTEGRATION METHOD AND ELECTRONIC DEVICE

(71) Applicant: CASIO COMPUTER CO., LTD., Tokyo (JP)

(72) Inventors: Hiroshi UEJIMA, Tokyo (JP); Hiroaki YOSHIZAWA, Tokyo (JP)

(73) Assignee: CASIO COMPUTER CO., LTD., Tokyo (JP)

(21) Appl. No.: 14/856,031

(22) Filed: Sep. 16, 2015

(30) Foreign Application Priority Data
Sep. 19, 2014 (JP) 2014-191868
Sep. 19, 2014 (JP) 2014-191879
Nov. 26, 2014 (JP) 2014-239383

(51) Int. Cl. G09B 19/02; H04L 29/06; H04L 29/08

(52) U.S. Cl. CPC G09B 19/025; H04L 67/12; H04L 67/32; H04L 67/42

(57) ABSTRACT

A server apparatus includes a processor. The processor is configured to perform: calculation target data receiving processing, group ID receiving processing, data registering processing and integrated calculation result transmitting processing. The calculation target data receiving processing receives calculation target data which is to be output from an information display device. The group ID receiving processing receives a group ID. The data registering processing registers the calculation target data received in the calculation target data receiving processing in association with the group ID received in the group ID receiving processing. The integrated calculation result transmitting processing integrates each calculation target data registered in association with the group ID in the data registering processing for each group ID and transmits a calculating result based on the integrated data.

### CROSS-REFERENCE TO RELATED APPLICATIONS

The present application claims the priority of Japanese Patent Application Nos. 2014-191868 filed on Sep. 19, 2014, 2014-191879 filed on Sep. 19, 2014 and 2014-239383 filed on Nov. 26, 2014, the contents of which being here incorporated for reference.

### FIELD OF THE INVENTION

The disclosure relates to a server apparatus, a data integration method and an electronic device.

### DESCRIPTION OF THE RELATED ART

In the related art, there is an information display device (which is referred to as a scientific calculator) configured to learn calculation processes of a variety of mathematical function formulas.

Regarding a using aspect of the information display device, JP-B-4720607 discloses that during a school class of displaying and analyzing a graph of a mathematical function formula, for example, students and a teacher use the information display devices, a teacher's device receives calculation target data such as graph data, which is transmitted from students' devices, integrates the data and enlarges, projects and displays integrated calculated data of the integration result with an overhead projector (OHP).

Also, recently, a calculation server that is accessed from a communication device such as a smart phone and is configured to provide a high-functional calculation service on the Internet has been used.

In the meantime, regarding a method of sharing data among a plurality of information devices without a communication function, JP-A-2011-076540) discloses that one device displays a QR code (registered trademark) corresponding to input text data and the other device captures the displayed QR code with a camera, converts the captured QR code into original text data and displays the same.

JP-B-4720607 discloses that the teacher's device receives the calculation target data from the plurality of information display devices and outputs the integrated calculated data. However, the respective information display devices should be associated with each other and connected in communication with each other in advance.

Also, when the technology suggested in JP-A-2011-076540 is used, the calculation target data from the information display device of each student can be input to the teacher's device without a communication function. However, it is not possible to easily group and manage the calculation target data of each student for each class.

It is therefore an object of the disclosure to provide a server apparatus, a data integration method and an electronic device capable of outputting calculation target data of respective information display devices as integrated result data in which the calculation target data is integrated for each group to which the respective information display devices belong.

### SUMMARY OF THE INVENTION

According to an aspect of the invention, a server apparatus includes a processor. The processor is configured to perform: calculation target data receiving processing, group ID receiving processing, data registering processing and integrated calculation result transmitting processing. The calculation target data receiving processing receives calculation target data which is to be output from an information display device. The group ID receiving processing receives a group ID. The data registering processing registers the calculation target data received in the calculation target data receiving processing in association with the group ID received in the group ID receiving processing. The integrated calculation result transmitting processing integrates each calculation target data registered in association with the group ID in the data registering processing for each group ID and transmits a calculating result based on the integrated data.

According to the disclosure, it is possible to output the calculation target data of the respective information display devices as the aggregated calculation result data of the result in which the calculation target data is aggregated for each group to which the respective information display devices belong.

### BRIEF DESCRIPTION OF THE DRAWINGS

FIG. 1 is a pictorial view depicting a configuration of a data integration system according to an illustrative embodiment of the disclosure.

FIG. 2 is a block diagram depicting a configuration of an electronic circuit of a scientific calculator 10.

FIG. 3 is a block diagram of a configuration of an electronic circuit of a compute server 30.

FIG. 4 is a flowchart depicting display control processing of the scientific calculator 10.

FIG. 5 is a flowchart depicting communication device processing of a communication device 20.

FIG. 6 is a flowchart depicting server processing (an embodiment 1) of the compute server 30.

FIG. 7 is a flowchart depicting the server processing (an embodiment 2) of the compute server 30.

FIGS. 8A, 8B, 8C, 8D, 8E and 8F illustrate display transition of the communication device 20 and the scientific calculator 10.

FIGS. 9A, 9B and 9C illustrate displays of a server homepage (HP) screen of the communication device 20.

FIGS. 10A, 10B, 10C, 10D and 10E illustrate display transition of the scientific calculator 10 and the communication device 20.

FIGS. 11A, 11B and 11C illustrate displays of the server homepage (HP) screen of a communication device 20B.

FIGS. 12A, 12B, 12C, 12D and 12E illustrate display transition of the scientific calculator 10 and the communication device 20.

FIGS. 13A and 13B illustrate displays of the server homepage (HP) screen of a communication device 20.

### DETAILED DESCRIPTION OF THE INVENTION

Hereinafter, illustrative embodiments of the disclosure will be described with reference to the drawings.

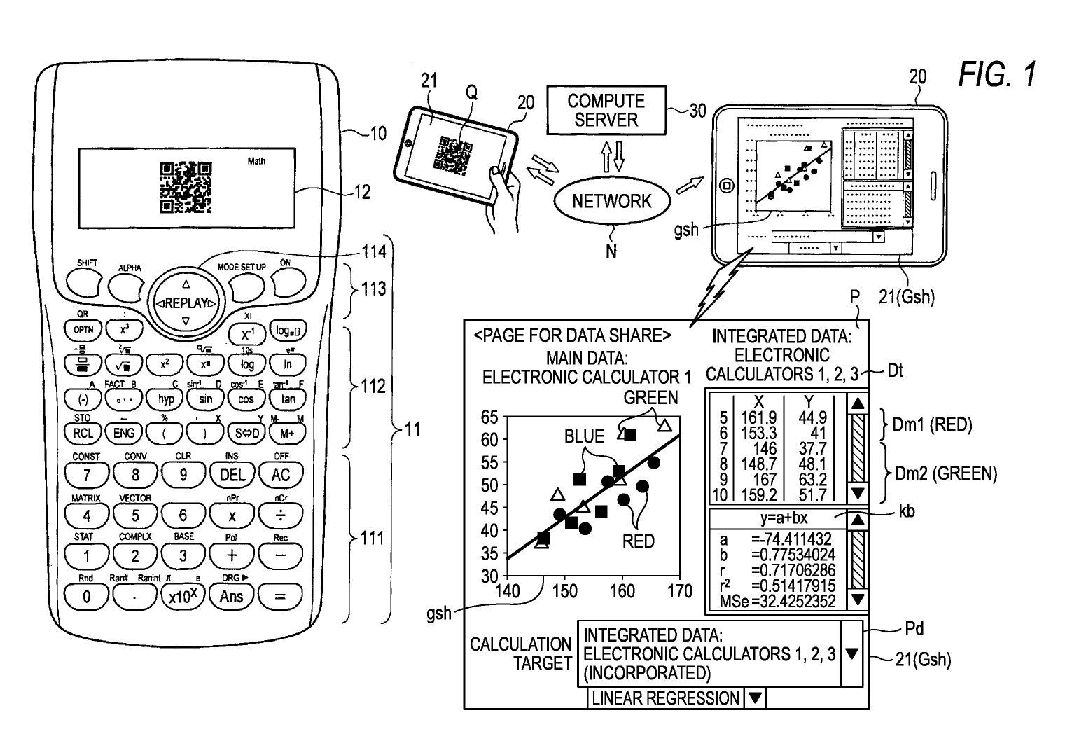

FIG. 1 is a pictorial view depicting a configuration of a data integration system according to an illustrative embodiment of the disclosure.

The data integration system includes a scientific calculator 10, which is an information display device that is to be used by a student, a communication device 20 with a camera such as a tablet PC having a camera, which is to be used by a student or a teacher, and a compute server 30.

The scientific calculator 10 has a function of converting a variety of data relating to calculation into a two-dimensional code such as a QR code (registered trademark) and displaying the same. The communication device 20 is configured to capture a display image of the two-dimensional code with the auxiliary camera thereof, to access the compute server 30 through a communication network N such as the Internet in accordance with data obtained from the acquired two-dimensional code, and to transmit calculation target data to the compute server 30. The compute server 30 is configured to integrate the calculation target data transmitted from the respective scientific calculators 10 for each group to which the students belong, to generate integrated calculation result data based on the calculation target data and to output the integrated calculation result data to the communication device 20. The communication device 20 is configured to receive the integrated calculation result data and to display the same on its own display device or to output the same to a projector P for enlargement display.

Also, in the below, a specific example where three students A, B and C belonging to the same group collect and input sample data of heights X and weights Y of Japanese, US and German children to the scientific calculators (the information display devices) 10, respectively, and learn the statistics by a statistical calculation function of the scientific calculator using the sample data is described.

When a command of code display is received from a user, the scientific calculator 10 converts the calculation target data of statistical calculation into a two-dimensional code including a homepage (HP) address of the calculation server (server apparatus) 30 and displays the same on a display unit 12, as a two-dimensional code image. Each of the students A, B and C captures the two-dimensional code image displayed on the scientific calculator 10 by the communication device 20, so that content data of the two-dimensional code is transmitted to the compute server 30.

In the meantime, the communication device 20 is not limited to the tablet PC having a camera, and may be a PDA (personal digital assistants) having a camera, a smart phone having a camera, a note PC (personal computer) having a camera or having a camera connected thereto, and the like.

Also, while the two communication devices 20 are depicted in FIG. 1, the communication device 20 is prepared for each student and each teacher. Also, the one scientific calculator 10 is just representatively depicted. Actually, the scientific calculators 10 are prepared in correspondence to the number of students. Also, the scientific calculator 10 may be additionally provided for the teacher.

The scientific calculator 10 has a small size so that the user can sufficiently grip and operate the same with one hand, due to the necessity of portability. A front surface of a main body of the scientific calculator 10 is provided with a key input unit 11 and a display unit 12.

The key input unit 11 includes a numeric/operation symbol key group 111 for inputting a numeric value and a expression or instructing execution of calculation, a mathematical function key group 112 for inputting a variety of mathematical functions or starting a memory function, a mode setting key group 113 for displaying menu screens of various operation modes and instructing settings of the various operation modes, and a cursor key 114 for moving a cursor displayed on the display unit 12 and selecting a data item.

As the numeric/operation symbol key group 111, [0] to [9] (the numeric value) keys, [+][−][×][÷] (four arithmetic operations) keys, [Ans] [=] (execution) key, [AC] (clear) key and the like are arranged.

As the mathematical function key group 112, [x−1] (reciprocal) key, [√□] (root) key, [□/□] (fraction) key, [sin] (sine) key and the like are arranged.

As the mode setting key group 113, [MODE] (mode) key, [SHIFT] (shift) key, [ALPHA] (alphabet) key, [ON] (power-on) key and the like are arranged.

In the meantime, the keys of the numeric/operation symbol key group 111 and the mathematical function key group 112 are respectively configured so that when the corresponding key is continuously operated after the [SHIFT] key is operated, it functions as a key described above the key, not a key function described on a top of the key.

The display unit 12 consists of a liquid crystal display unit of a dot matrix type.

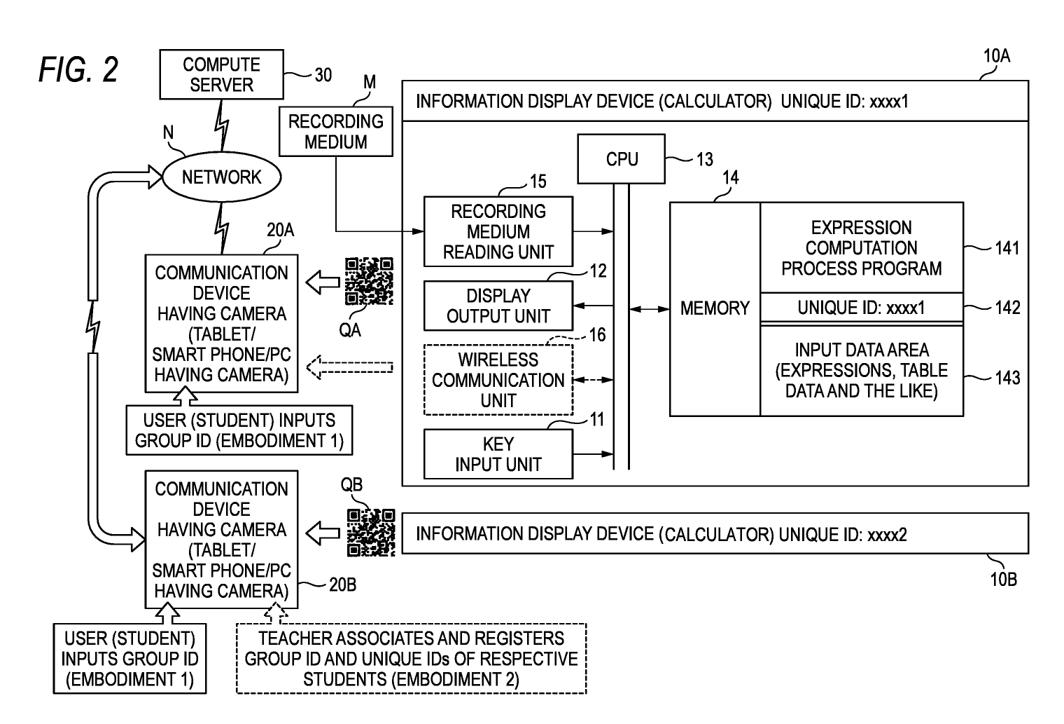

FIG. 2 is a block diagram depicting a configuration of an electronic circuit of a scientific calculator 10.

Here, one of the scientific calculators 10A, 10B, 10C possessed by the plurality of students A, B, C is described as the scientific calculator 10.

An electronic circuit of the scientific calculator 10 has a CPU 13, which is a computer, a memory 14 and a recording medium reading unit 15, in addition to the key input unit 11 and the display unit 12. Also, as shown with the dotted line in FIG. 2, the electronic circuit may have a wireless communication unit 16.

The CPU 13 is configured to control operations of the respective units of the electronic circuit and to execute a variety of arithmetic processing, in response to a expression calculation processing program 141 stored in the memory 14. The expression calculation processing program 141 cannot be rewritten by a user's operation on the key input unit 11.

In the memory 14, a unique ID 142 is also stored as user-unrewritable information. The unique ID 142 is an ID specific to each scientific calculator 10.

In the memory 14, an input data area 143 is secured so as to store data that can be rewritten by the user, in addition to the user-unrewritable information.

Here, the input data area 143 is sequentially input with data from the key input unit 11 and stores therein expression data and table data. In addition, the input data area 143 stores therein statistical functions, function types such as calculation types and data necessary for statistical calculation.

The wireless communication unit 16 has a function of performing communication with an external device, such as Bluetooth (registered trademark) and infrared communication.

In the scientific calculator 10 configured as described above, the CPU 13 controls the operations of the respective units of the electronic circuit in accordance with commands described in the expression calculation processing program 141, thereby implementing a display control function as described later.

Each of the communication devices 20A, 20B, 20C is configured to capture the two-dimensional code image displayed on the display unit 12 of each of the scientific calculators 10A, 10B, 10C and to transmit the content data of the captured two-dimensional code image to the compute server 30 of which a homepage (HP) address is preset, through the communication network N.

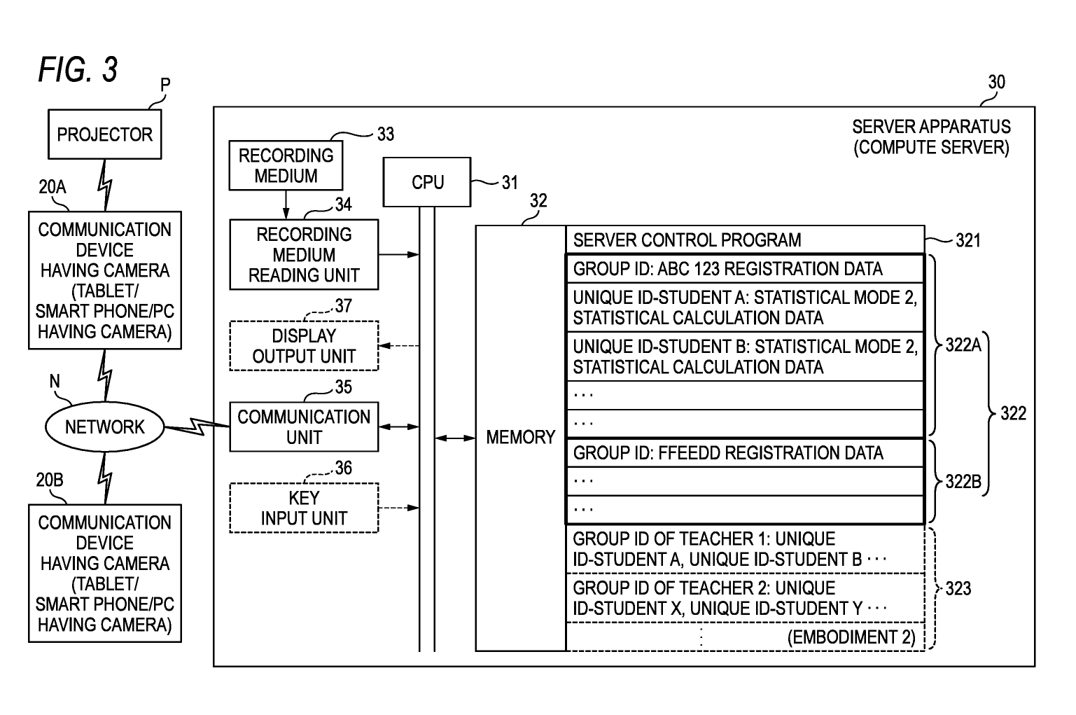

FIG. 3 is a block diagram of a configuration of an electronic circuit of the compute server 30.

The electronic circuit of the compute server 30 has a CPU 31, which is a computer, a memory 32, a recording medium 33, a recording medium reading unit 34, and a communication unit 35. Also, as shown with the dotted line in FIG. 3, the electronic circuit may have a key input unit 36 or a display unit 37.

The CPU 31 is configured to control operations of the respective units of the electronic circuit, in response to a server control program 321 stored in advance in the memory 32, thereby executing a variety of processing in accordance with the content data (hereinafter, referred to as barcode content data) of the two-dimensional code (QR code) from the communication device 20 received at the communication unit 35. The server control program 321 may be read from the recording medium 33 such as a memory card into the memory 32 through the recording medium reading unit 34 or may be downloaded from a Web server (not shown) on the communication network N to the memory 32 through the communication unit 35.

In the memory 32, a registration data memory 322 for registering the barcode content data received from the communication device 20 for each group ID is secured. In the registration data memory 322, a dedicated data area 322 for each group ID is prepared, and the barcode content data obtained from the scientific calculator 10 of each student is registered for each group.

In an embodiment 1 of this illustrative embodiment, the group ID stored in the compute server 30 is registered in advance by an access from the communication device 20 of the teacher who is in charge of the corresponding group. When the first barcode content data is received from the communication device 20 of the student, the compute server 30 requests the communication device 20 to input a group ID. When the student inputs a group ID, the compute server 30 registers the received barcode content data (including an calculator-unique ID) in the dedicated data area 322.

In an embodiment 2 of this illustrative embodiment, when an access from the communication device 20 of the teacher is made, a group ID of a group that is handled by the teacher and the calculator-unique IDs of the respective students belonging to the corresponding group are associated and registered in advance. In the embodiment 2, the barcode content data received from the communication device 20 of the student is registered in the dedicated data area of the corresponding group ID, in accordance with the calculator-unique ID included in the barcode content data.

In the compute server 30 configured as described above, the CPU 31 controls the operations of the respective units of the electronic circuit in accordance with commands described in the server control program 321 and the software and the hardware operate in cooperation with each other, so that a server processing function as described later is implemented.

The communication device 20 may display integrated calculated data and calculation result data received from the compute server 30 through the communication network N on a display unit 21 and enlarge, project and display the same through the connected projector P.

Subsequently, operations of the data integration system having the above configuration are described.

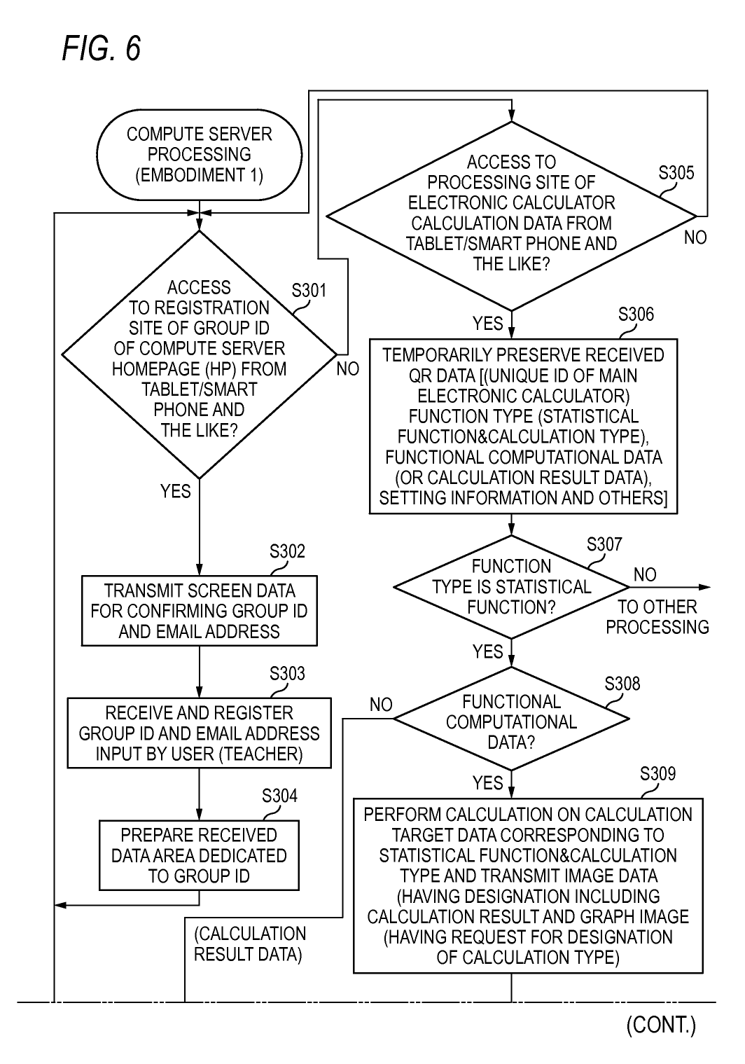

FIG. 6 is a flowchart depicting server processing (embodiment 1) of the compute server 30.

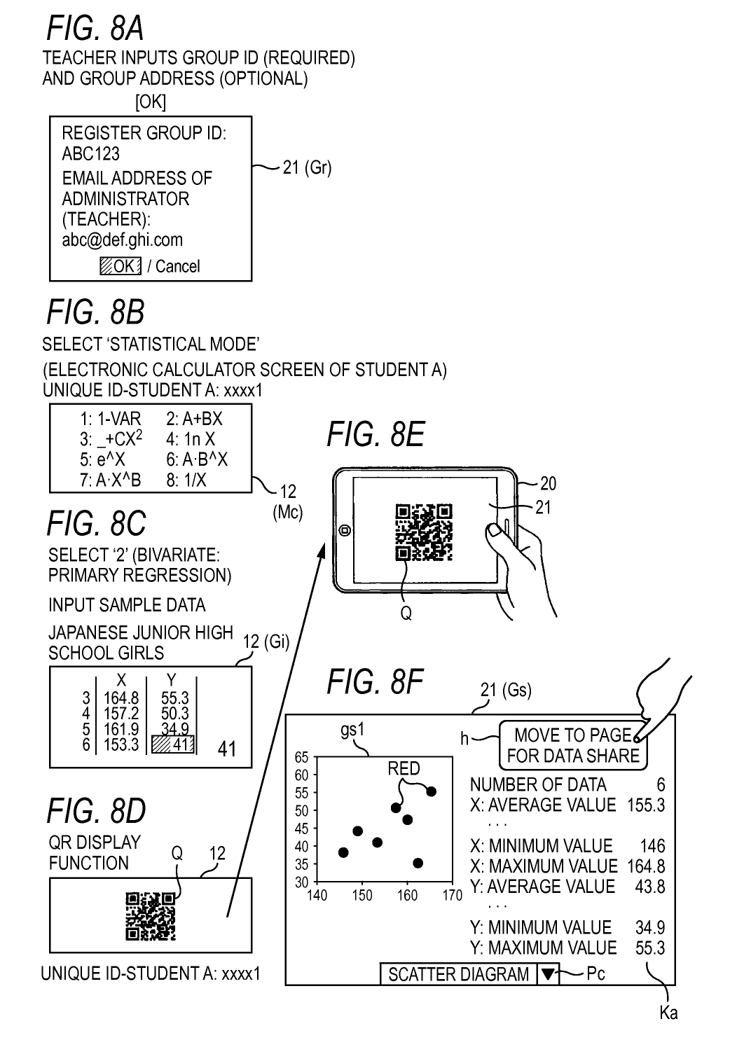

FIGS. 8A, 8B, 8C, 8D, 8E and 8F illustrate transition of a display operation associated with the registration of the group ID by the teacher's communication device 20, a display operation at a statistical mode of the scientific calculator 10A of the student A and a display operation associated with an access of the communication device 20A of the student A to the compute server 30.

In the below descriptions, the processing of the scientific calculator 10, the communication device 20 and the compute server 30 is mixed over time. Therefore, before the description, the symbol < > is used so as to indicate in which apparatus the processing is to be executed.

<Server>

First, the operations of the compute server 30 (embodiment 1) are described with reference to FIG. 6.

When it is determined that the teacher's communication device 20 accesses a group ID registration site of the homepage (HP) of the compute server 30 (step S301), a group ID registration screen Gr for urging the user to input a group ID and an email address is transmitted to the communication device 20, which is a source of the access, and is displayed on the display unit 21 (step S302), as shown in FIG. 8A.

When a group ID [ABC123] of a group, which is handled by the teacher, and an email address [abc@def.ghi.com] are input and an [OK] key is operated at the teacher's communication device 20 in accordance with the group ID registration screen Gr, the input group ID and email address are transmitted to the compute server 30.

In the compute server 30, the group ID and email address transmitted from the teacher's communication device 20 are registered in the registration data memory 322 (step S303), and the dedicated data area 322 for the corresponding group ID is prepared (step S304).

<Scientific Calculator A>

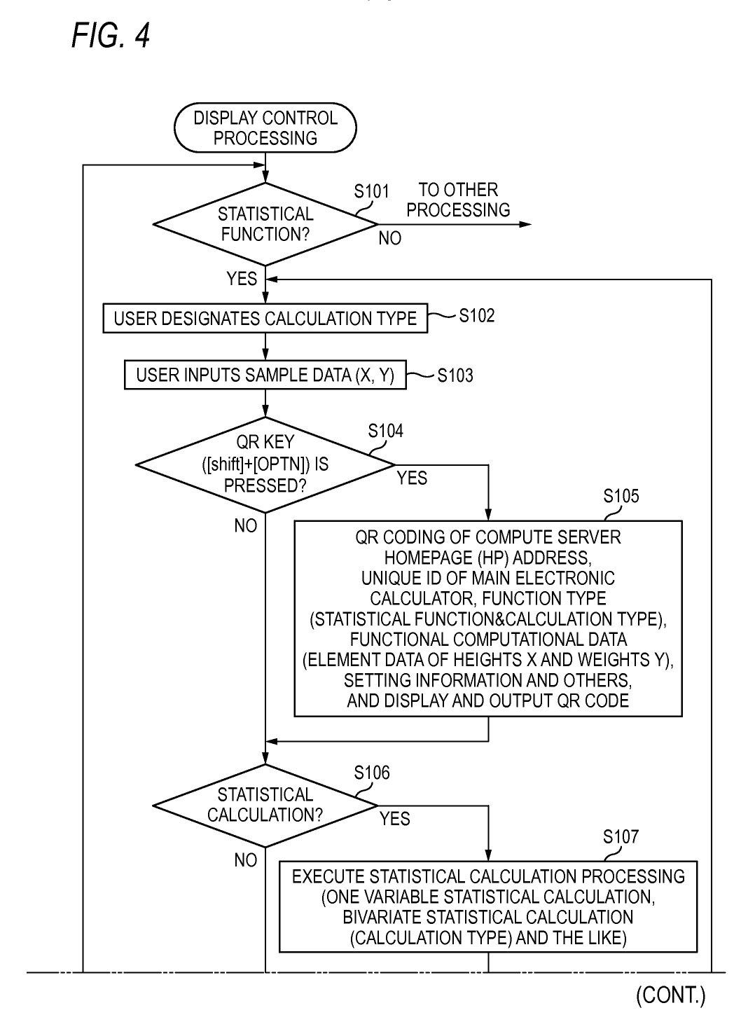

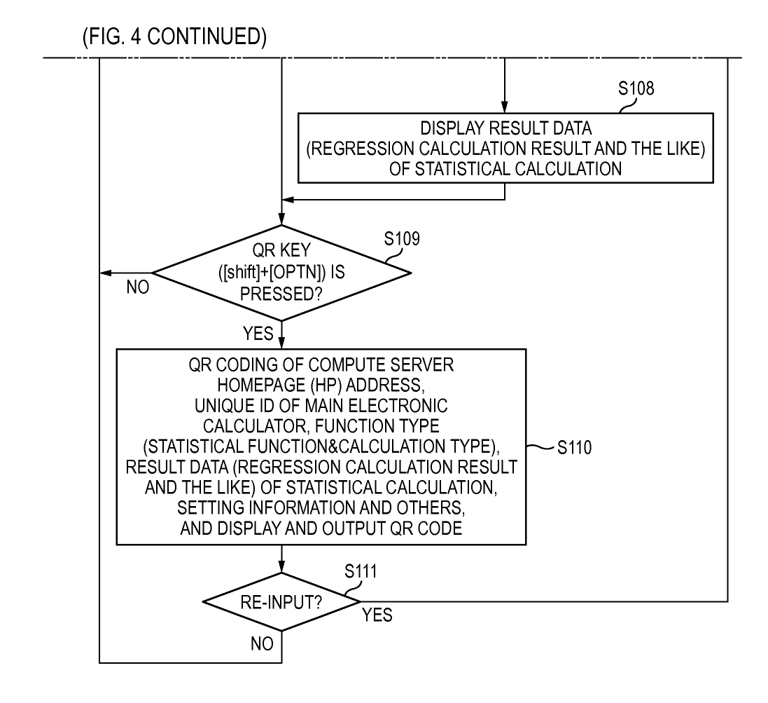

FIG. 4 is a flowchart depicting display control processing of the scientific calculator 10.

When a statistical calculation function is selected in a calculation function list menu (not shown) (step S101), which is displayed as the [MODE] key of the scientific calculator (information display device) 10A of the student A is operated, the operation mode is set to the statistical mode and a statistical calculation type list menu Mc for designating a type of the statistical calculation is displayed on the display unit 12, as shown in FIG. 8B.

When the user designates a desired calculation type (here, [2: A+BX] to bivariate statistical calculation; primary regression) (step S102), a table data input screen (bivariate input screen) Gi for inputting computational element (table) data in the bivariate statistical calculation is displayed, as shown in FIG. 8C.

When the computational element data (here, sample data of heights X and weights Y of Japanese junior high school girls) is input on the table data input screen (bivariate input screen) Gi, the designated calculation type (bivariate statistical calculation) and the input element data X, Y are stored in the input data area 143 of the memory 14 (step S103).

Here, when the [QR] ([SHIFT]+[OPTN]) key of the key input unit 11 is operated (step S104), a two-dimensional code is generated and displayed as shown in FIG. 8D (step S105). The two-dimensional code includes the homepage (HP) address of the compute server 30, a unique ID (xxxx1) of the main calculator, a calculation function type (bivariate statistical calculation; primary regression), functional computational data (computational element data (X, Y)), setting information and the others, which are two-dimensionally coded.

The setting information includes setting information of various modes such as an angle mode, a rounding mode, a display mode and the like.

When the [=] key is operated to instruct calculation execution (step S106 (Yes)) after the statistical calculation is designated and the computational element data (X, Y) is input in accordance with the processing of steps S101 to S103, the statistical calculation (bivariate statistical calculation; primary regression) of the designated type is executed (step S107).

At this time, based on the computational element data (X, Y), parameters a, b of a regression formula (y=a+bx), a correlation coefficient r, a determination coefficient r², and an average square error MSe are calculated and displayed on the display unit 12, as statistical calculation result data (step S108).

When the [QR] key is operated (step S109) after the designated statistical calculation is executed, the homepage (HP) address of the compute server 30, the unique ID (xxxx1) of the main calculator, the calculation function type being executed (the statistical calculation function and the calculation type (bivariate statistical calculation; primary regression)), the statistical calculation result data, the setting information and the others are two-dimensionally coded as the barcode content data and displayed the display unit 12 (step S110).

At this time, when the computational element data is input again, the processing returns to step S102 (step S111 to S102), and otherwise to step S101.

<Communication Device>

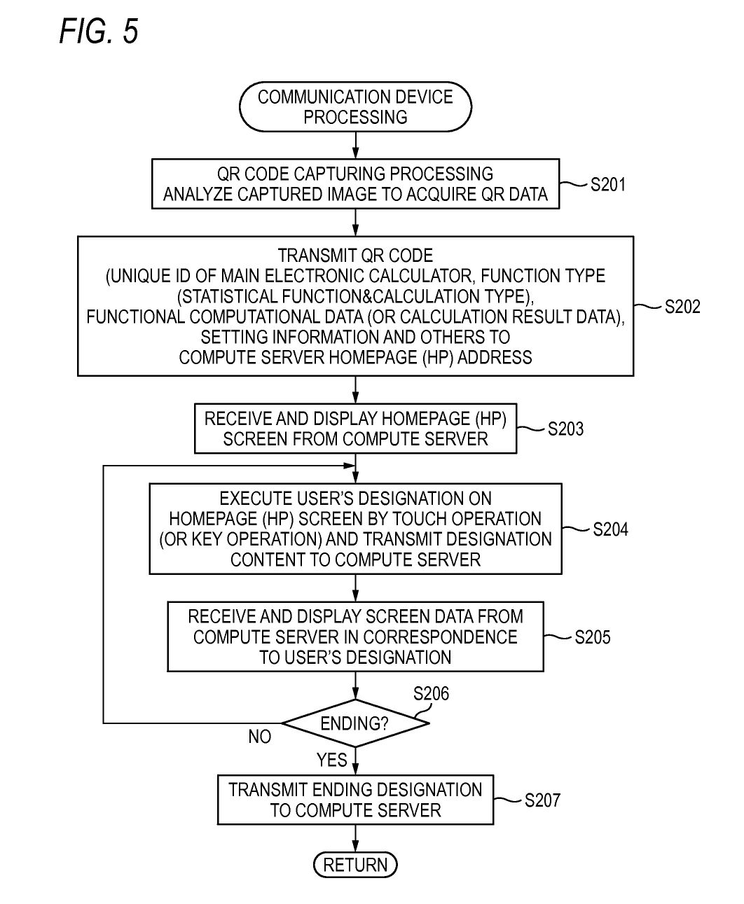

FIG. 5 is a flowchart depicting communication device processing of the communication device 20.

When the two-dimensional code image Q displayed on the display unit 12 of the scientific calculator 10A of the student A is captured by the communication device (e.g., tablet PC) 20A of the student A, as shown in FIG. 8E, the contents of the two-dimensional code image Q are decoded (step S201). Then, the calculator-unique ID (xxxx1), the calculation function type (the statistical calculation function and the calculation type (bivariate statistical calculation; primary regression)), the functional computational data (the computational element data (X, Y)), the setting information, and the others, which are the content data of the barcode, are transmitted to the compute server 30 through the communication network N (step S202) (refer to FIG. 2).

<Server>

When the compute server 30 receives the barcode content data from the communication device 20A of the student A, the calculation server determines that the access to the processing site of the calculator calculation data is made (step S305 (Yes)). Then, the received barcode content data ‘the calculator-unique ID (xxxx1), the calculation function type (the statistical calculation function and the calculation type (bivariate statistical calculation; primary regression)), the functional computational data (computational element data (X, Y)), the setting information, and the others’ is temporarily preserved in the memory 32 (step S306). Also, a communication path between the compute server 30 and the communication device 20A of the student A is established at a point of time that the barcode content data is received, and then the communication is performed one-on-one between the compute server 30 and the communication device 20A of the student A. Thereby, the barcode content data is associated with a group ID, which is to be received thereafter, in the compute server 30.

When it is determined that the barcode content data temporarily preserved in the memory 32 is data of the statistical calculation function (step S307 (Yes)), it is determined whether the barcode content data includes the functional computational data (computational element data (X, Y)) (or includes the statistical calculation result data), too (step S308).

Here, when it is determined that the barcode content data includes the functional computational data (step S308 (Yes)), too, the statistical calculation based on the functional computational data (X, Y) is executed, in response to the calculation function type (statistical calculation) and the calculation type (bivariate statistical calculation; primary regression). As a result of the calculation, image data Gs (refer to FIG. 8F) of a calculation result including data Ka such as the number of data, average values, minimum values, maximum values and the like of the heights X and weights Y, and a graph image (scatter diagram) gs1 is prepared and transmitted to the communication device 20A (step S309). At this time, the prepared graph image (scatter diagram) gs1 is prepared with the red plot points.

In the meantime, the image data Gs (refer to FIG. 8F) of the calculation result is added with a pull-down menu Pc for calculation type designation request for enabling a user to designate a calculation type, and the calculation type of the pull-down menu Pc is set to ‘scatter diagram’, as a default.

When the image data Gs (refer to FIG. 8F) of the calculation result is transmitted, an icon h (refer to FIG. 8F) ‘move to page for data share’ for sharing and integrating the calculation result data among the students belonging to the same group is also transmitted (step S310).

<Communication Device>

When the communication device 20A of the student A receives the image data Gs of the calculation result and the icon h ‘move to page for data share’ transmitted from the compute server 30, a server homepage (HP) screen in which the icon h is incorporated in the image data Gs of the calculation result is displayed on the display unit 21, as shown in FIG. 8F (step S203).

In the server homepage (HP) screen, the icon h ‘move to page for data share’ is touched, the designation content is transmitted to the compute server 30 (step S204).

<Server Apparatus>

When the compute server 30 receives the designation content ‘move to page for data share’ of the icon h from the communication device 20A (step S311 (Yes)), it is determined whether the calculator-unique ID (xxxx1), which is included in the barcode content data temporarily stored in the registration data memory 322 of the memory 32 in step S306, has been registered (step S312).

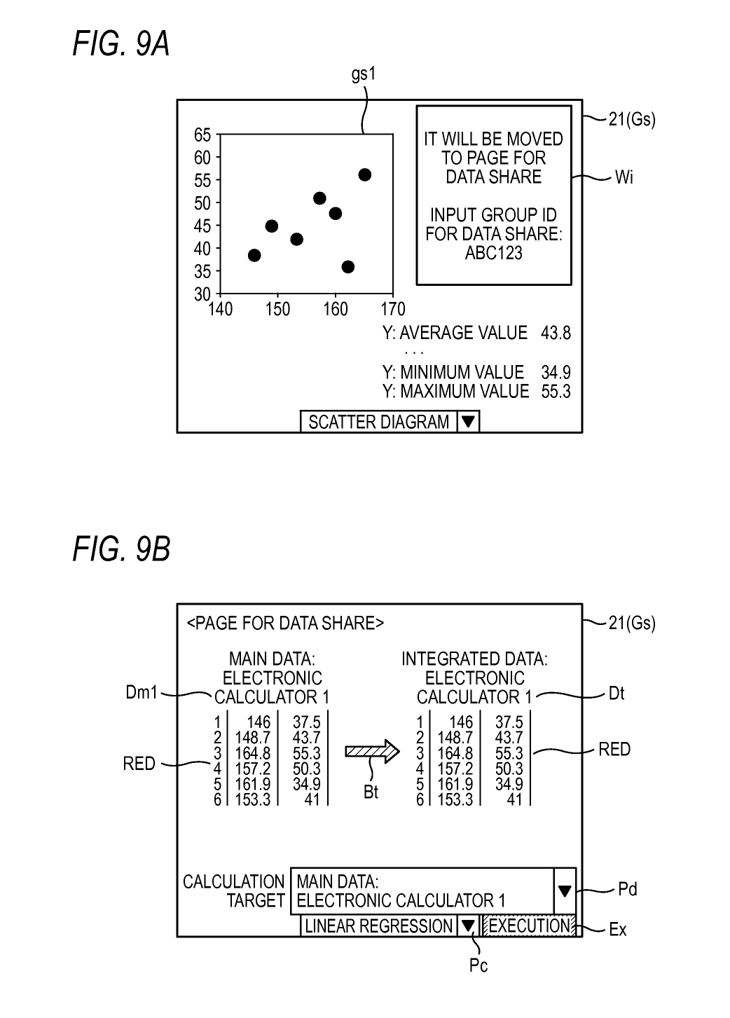

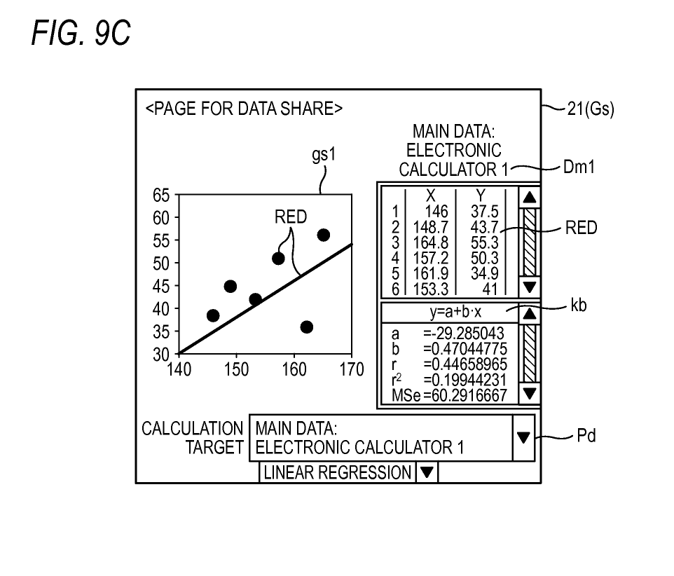

When it is determined that the calculator-unique ID (xxxx1) has not been registered (step S312 (No)), a request for input of a group ID (refer to FIG. 9A) is transmitted to the communication device 20A of the student A (step S313).

<Communication Device>

FIGS. 9A, 9B and 9C depict display operations on the server homepage (HP) screen (at a state where only the barcode content data from the calculator 10A of the student A is preserved) at the communication device 20A of the student A.

When the communication device 20A of the student A receives the request for input of the group ID transmitted from the compute server 30, a group ID input window Wi is displayed (step S205), as shown in FIG. 9A.

On the group ID input window Wi, when a group ID (here, ‘ABC123’) of the student A is input by the user's operation, the input group ID is transmitted to the compute server 30 (step S204).

<Server Apparatus>

When the compute server 30 receives the group ID ‘ABC123’ from the communication device 20A, the calculation function type, the calculation type and the functional computational data are registered with being associated with the calculator-unique ID, which is included in the temporarily preserved barcode content data, in the dedicated data area 322A corresponding to the group ID (step S314).

On the other hand, when it is determined in step S312 that the calculator-unique ID has been registered (step S312 (Yes)), the temporarily preserved barcode content data is registered in the dedicated data area 322A corresponding to the registered group ID ‘ABC123’ of the student A (step S315).

In this way, when the barcode content data by the scientific calculator 10A is registered in the dedicated data area 322A corresponding to the group ID of the student A, image data for data share Gsh (refer to FIG. 9B) including main calculator calculation target data Dm1, which is obtained from the registered calculator 10A of the student A, and integrated (aggregated) calculation target data Dt, which is obtained by integrating the functional computational data obtained from the calculators of the other students belonging to the same group ID, is prepared and transmitted to the communication device 20A of the student A (step S316).

A pull-down menu Pd for requesting designation of the calculation target data and the pull-down menu Pc for requesting designation of the calculation type are also transmitted to the communication device 20A (step S317).

<Communication Device>

When the communication device 20A of the student A receives the image data for data share Gsh and the pull-down menus Pd, Pc transmitted from the compute server 30, a server homepage (HP) screen (Gsh) in which the pull-down menu Pd and the pull-down menu Pc are added to the image data for data share Gsh is displayed on the display unit 21 (step S205), as shown in FIG. 9B.

Here, since only the barcode content data obtained from the scientific calculator 10A of the student A is registered in the dedicated data area 322A for the group ID ‘ABC123’ of the compute server 30, the contents of the integrated (aggregated) calculation target data Dt of the server homepage (HP) screen (Gsh) are the same as the main calculator calculation target data Dm1.

Also, regarding the server homepage (HP) screen (image data for data share Gsh) including the main calculator calculation target data Dm1 and the integrated (aggregated) calculation target data Dt, the integrated (aggregated) calculation target data Dt may be updated to the latest data as the user touches an integration button Bt.

In the server homepage (HP) screen (Gsh) depicted in FIG. 9B, when the item ‘main data: calculator 1’, in which only the data obtained from the scientific calculator 10A is a calculation target, is designated by the pull-down menu Pd, the item ‘linear regression’ is designated by the pull-down menu Pc and the [Execution] button Ex is touched, the designation contents (calculation target ‘main data: calculator 1’, calculation type ‘linear regression’) are transmitted to the compute server 30 (step S204).

<Server Apparatus>

When the compute server 30 receives the designation contents (calculation target ‘main data: calculator 1’, calculation type ‘linear regression’) transmitted from the communication device 20A (step S318), the parameters a, b of the regression formula (y=a+bx), the correlation coefficient r, the determination coefficient r², and the average square error MSe are calculated based on the statistical calculation target data (X, Y) of the Japanese junior high school girls registered in the data area 322A, and image data for data share Gsh (refer to FIG. 9C) including the calculation target data Dm1, the calculation result Kb and the graph image (linear regression) gs1 is prepared and transmitted to the communication device 20A of the student A, as the server homepage (HP) screen (Gsh) (step S319).

At this time, the calculation target data Dm1 and the graph image (linear regression) gs1 associated with the calculator-unique ID (xxxx1) and prepared by the compute server 30 are prepared by red numeric values, plot points and graph image (linear regression).

<Communication Device>

When the communication device 20A of the student A receives the server homepage (HP) screen (image data for data share Gsh) transmitted from the compute server 30, the received server homepage (HP) screen (Gsh) is displayed on the display unit 21 (step S205), as shown in FIG. 9C.

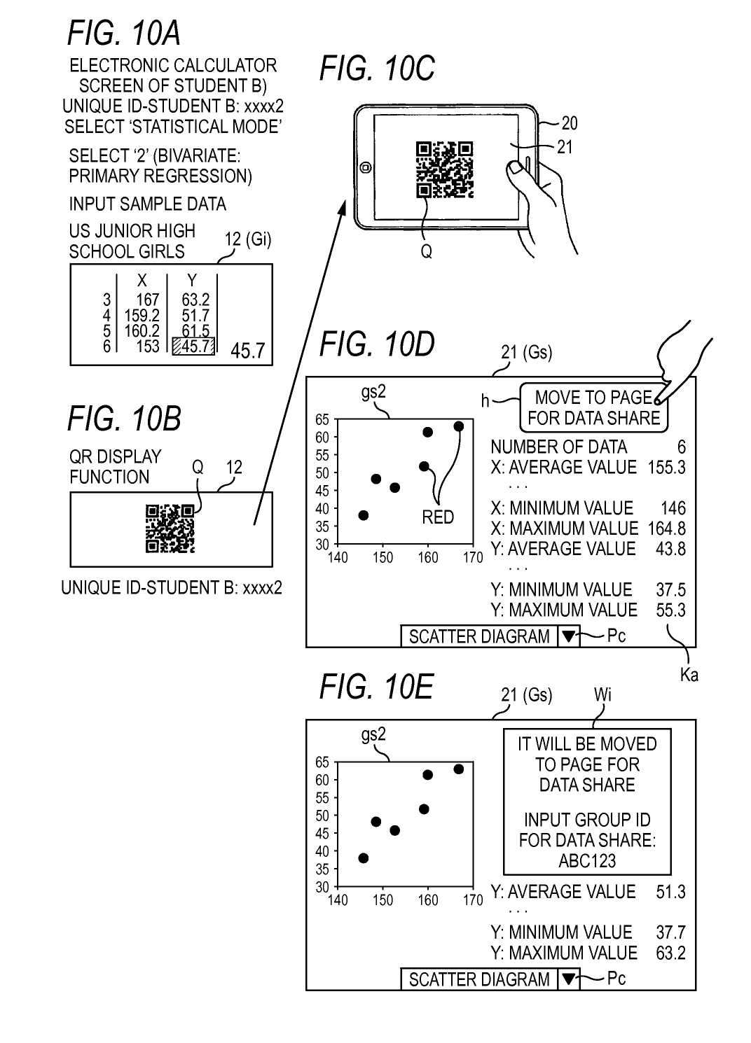

FIGS. 10A, 10B, 10C, 10D and 10E depict transition of display operations at the statistical mode of the scientific calculator 10B of the student B and display operations associated with the access of the communication device 20B of the student B to the compute server 30.

<Scientific Calculator B>

As shown in FIG. 10A, when the sample data of heights X and weights Y of US junior high school girls is input in the table data input screen Gi under the statistical mode at the scientific calculator 10B of the student B, like the scientific calculator 10A, the designated calculation type (bivariate statistical calculation) and the input element data (X, Y) are stored in the data area 143 of the memory 14 (steps S101 to S103).

When the [QR] key is operated (step S104) so as to transmit the calculation target data by the scientific calculator 10B of the student B to the compute server 30, subsequently to the student A, as shown in FIG. 10B, a two-dimensional code image is generated and displayed on the display unit 12 (step S105).

<Communication Device>

At this time, as shown in FIG. 10C, when the student B captures the two-dimensional code image Q with the communication device 20B, the contents of the two-dimensional code are decoded (step S201), and the barcode content data ‘the calculator-unique ID (xxxx2), the calculation function type (the statistical calculation function and the calculation type (bivariate statistical calculation; primary regression)), the functional computational data (computational element data (X, Y)), the setting information, and the others’ is transmitted to the homepage (HP) address of the compute server 30 (step S202).

<Server>

The compute server 30 temporarily preserves the barcode content data received from the communication device 20B of the student B, like the case of the student A (steps S305, S306). Then, the statistical calculation is performed based on the barcode content data, and image data Gs (refer to FIG. 10D) of the calculation result including the calculation result Ka and the graph image (scatter diagram) gs2 is prepared and transmitted to the communication device 20B (steps S305 to S310). Here, the graph image (scatter diagram) gs2 based on the statistical data of the student B, which is prepared at the compute server 30, is also prepared by the red plot points.

<Communication Device>

When the communication device 20B receives the image data Gs of the calculation result and the icon h ‘move to page for data share’, the server homepage (HP) screen is displayed on the display unit 21 (step S203), as shown in FIG. 10D.

Also in the server homepage (HP) screen (Gs) displayed on the communication device 20B, when the icon h ‘move to page for data share’ is touched and the content is transmitted to the compute server 30 (step S204), the compute server 30 determines that the calculator-unique ID (xxxx2), which is included in the temporarily preserved barcode content data from the scientific calculator 10B, has not been registered (step S311, S312 (No)), and the request for input of the group ID (refer to FIG. 10E) is transmitted to the communication device 20B (step S313).

On the communication device 20B of the student B, the group ID input window Wi is displayed (step S205), as shown in FIG. 10E. When the group ID ‘ABC123’ of the student B is input and is transmitted to the compute server 30 (step S204), the calculator-unique ID (xxxx2), which is included in the temporarily preserved barcode content data, is registered with being associated in the dedicated data area 322A corresponding to the received group ID of the student B and the barcode content data is registered at the compute server 30 (step S314).

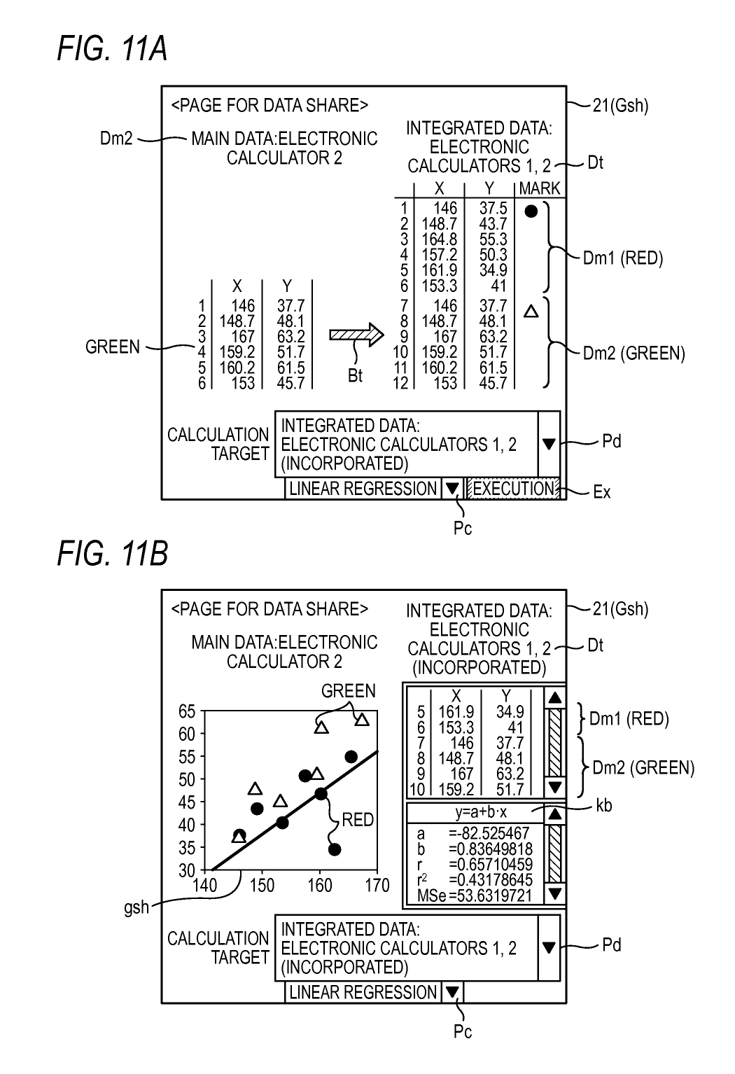

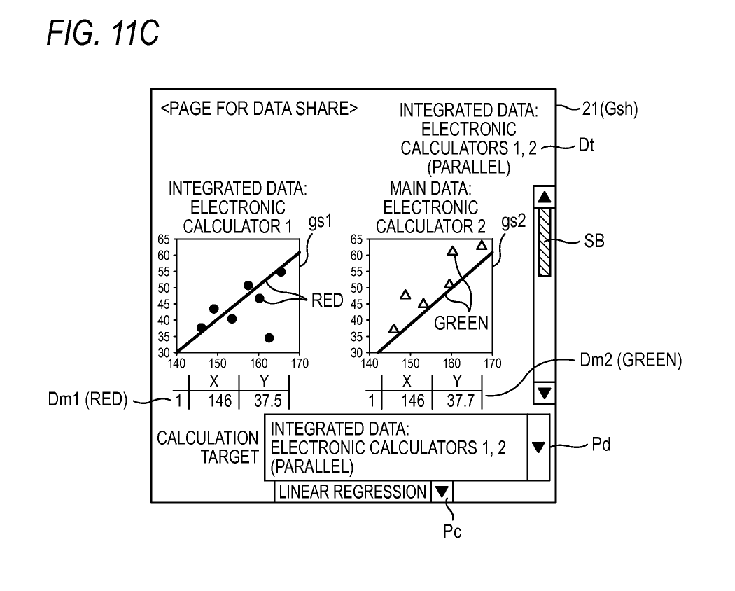

FIGS. 11A, 11B and 11C depict the display operations of the server homepage (HP) screen (at a state where the respective barcode content data from the respective scientific calculators 10A, 10B of the two students A, B is preserved) on the communication device 20B of the student B.

In this way, when the barcode content data by the scientific calculator 10B is registered in the dedicated data area 322A corresponding to the group ID of the student B, image data for data share Gsh (refer to FIG. 11A) including calculation target data Dm2 of the registered student B, and integrated (aggregated) calculation target data Dt, which is obtained by integrating the calculation target data Dm1 of the student A, is prepared and transmitted to the communication device 20B of the student B (step S316).

Also, the pull-down menu Pd and the pull-down menu Pc are transmitted to the communication device 20A (step S317).

Meanwhile, in the image data for data share Gsh, the calculation target data Dm1 obtained from the calculator A is identified by the red numerical values and mark ‘’, and the calculation target data Dm2 obtained from the calculator B are identified by the green numerical values and mark ‘Δ’.

The server homepage (HP) screen (Gsh) in which the pull-down menu Pd and the pull-down menu Pc are added to the image data for data share Gsh is displayed on the display unit 21 of the communication device 20B (step S205), as shown in FIG. 11A.

Here, the respective barcode content data obtained from the scientific calculators 10A, 10B of the two the students A, B is registered in the dedicated data area 322A of the compute server 30 for the group ID ‘ABC123’. Therefore, the item ‘main data: calculator 2’ for designating, as the calculation target, only data received this time from the scientific calculator 10B, the item ‘integrated data: calculators 1, 2 (incorporated)’ for designating, as the calculation target, data obtained by incorporating and merging the data from the two scientific calculators 10A, 10B, and the item ‘integrated data: calculators 1, 2 (parallel)’ for designating, as the calculation target, the functional computational data in parallel from the two scientific calculators 10A, 10B are set to be selectable in the pull-down menu Pd.

As shown in FIG. 11A, when the item ‘integrated data: calculators 1, 2 (incorporated)’ is designated by pull-down menu Pd, the item ‘linear regression’ is designated by the pull-down menu Pc, and the [Execution] button Ex is touched in the server homepage (HP) screen (Gsh) displayed on the communication device 20B, the designation contents are transmitted to the compute server 30 (step S204).

<Server>

When the compute server 30 receives the designation contents transmitted from the communication device 20B (step S318), the statistical calculation corresponding to the calculation target ‘integrated data: calculators 1, 2 (incorporated)’ and the calculation type ‘linear regression’ of the designation contents is executed. Here, based on the integrated (aggregated) calculation target data (incorporated) Dt in which the statistical calculation target data (X, Y) of Japanese junior high school girls and the statistical calculation target data (X, Y) of US junior high school girls registered with being associated with the respective calculator-unique IDs (xxxx1) and (xxxx2) are incorporated and merged, the parameters a, b of the regression formula (y=a+bx), the correlation coefficient r, the determination coefficient r², and the average square error MSe are calculated. Then, the image data for data share Gsh (refer to FIG. 11B) including the integrated (aggregated) calculation target data (incorporated) Dt, the calculation result Kb and the integrated graph image (linear regression) gsh is prepared and transmitted to the communication device 20B of the student B, as the server homepage (HP) screen (Gsh) (step S319).

<Communication Device>

When the communication device 20B receives the server homepage (HP) screen (the image data for data share Gsh), which includes the integrated (aggregated) calculation target data (incorporated) Dt, the calculation result Kb and the integrated graph image (linear regression) gsh and is transmitted from the compute server 30, the received server homepage (HP) screen (Gsh) is displayed on the display unit 21 (step S205), as shown in FIG. 11B.

Thereby, it is possible to simply display the server homepage (HP) screen (the image data for data share Gsh) including the integrated (aggregated) calculation target data (incorporated) Dt, in which the statistical calculation target data (heights/weights of Japanese junior high school girls) of the student A and the statistical calculation target data (heights/weights of US junior high school girls) of the student B are incorporated and merged, the statistical calculation result Kb and the integrated graph image (linear regression) gsh, on the display unit 21 of the tablet PC and the like, which is the communication device 20B of the student B (or teacher), as shown in FIG. 11B. Then, the server homepage (HP) screen (the image data for data share Gsh) is displayed with being enlarged and projected by the projector P, so that all the classes of the students and teacher belonging to the same group (ID; ABC123) can check and learn the incorporated and integrated contents of the statistical calculation relating to the heights/weights of Japanese and US junior high school girls.

Also, when the item ‘integrated data: calculators 1, 2 (parallel)’ is designated by the pull-down menu Pd, the item ‘linear regression’ is designated by the pull-down menu Pc and the [Execution] button Ex is touched on the server homepage (HP) screen (Gsh) shown in FIG. 11A, the designation contents are transmitted to the compute server 30 (step S204).

<Server>

When the compute server 30 receives the designation contents transmitted from the communication device 20B of the student B (step S318), the statistical calculation corresponding to the calculation target ‘integrated data: calculators 1, 2 (parallel)’ and the calculation type ‘linear regression’ of the designation contents is executed. Here, based on the integrated (aggregated) calculation target data (parallel) Dt in which the calculation target data (X, Y) Dm1 of Japanese junior high school girls and the calculation target data (X, Y) Dm2 of US junior high school girls registered with being associated with the respective calculator-unique IDs (xxxx1) and (xxxx2) are in parallel, the parameters a, b of the regression formula (y=a+bx), the correlation coefficient r, the determination coefficient r², and the average square error MSe are calculated, and the respective calculation target data Dm1, Dm2 and the respective calculation results Kb1, Kb2 are prepared and transmitted as aggregated calculation result data of an aggregation calculation result thereof. More specifically, the image data for data share Gsh (refer to FIG. 11C), which includes the respective calculation target data Dm1, Dm2, the image data in which the character data of the respective calculation results Kb1, Kb2 is imaged and the respective graph images (linear regressions) gs1, gs2, is transmitted to and displayed on the communication device 20B of the student B, as the server homepage (HP) screen (Gsh) in which the image data for data share Gsh is prepared as the integrated image data integrated for each group ID (step S319/S205).

At this time, only parts of the respective calculation target data Dm1, Dm2 and only the graph images (linear regressions) gs1, gs2 are displayed in the server homepage (HP) screen (Gsh) shown in FIG. 11C. However, it is possible to display the entire calculation target data Dm1, Dm2 and the respective calculation results Kb1, Kb2 by operating a scroll bar SB provided at a right end of the server homepage (HP) screen (Gsh) to scroll the server homepage (HP) screen (Gsh).

Thereby, it is possible to simply display the server homepage (HP) screen (the image data for data share Gsh) including the respective calculation target data Dm1, Dm2, in which the statistical calculation target data (heights/weights of Japanese junior high school girls) of the student A and the statistical calculation target data (heights/weights of US junior high school girls) of the student B are integrated in parallel, the respective calculation results Kb1, Kb2 and the respective graph images (linear regressions) gs1, gs2, on the display unit 21 of the tablet PC and the like, which is the communication device 20B of the student B (or teacher), as shown in FIG. 11C. Then, the server homepage (HP) screen (the image data for data share Gsh) is displayed with being enlarged and projected by the projector P, so that all the classes of the students and teacher belonging to the same group (ID; ABC123) can check and learn the contents of the statistical calculation integrated in parallel relating to the heights/weights of Japanese and US junior high school girls.

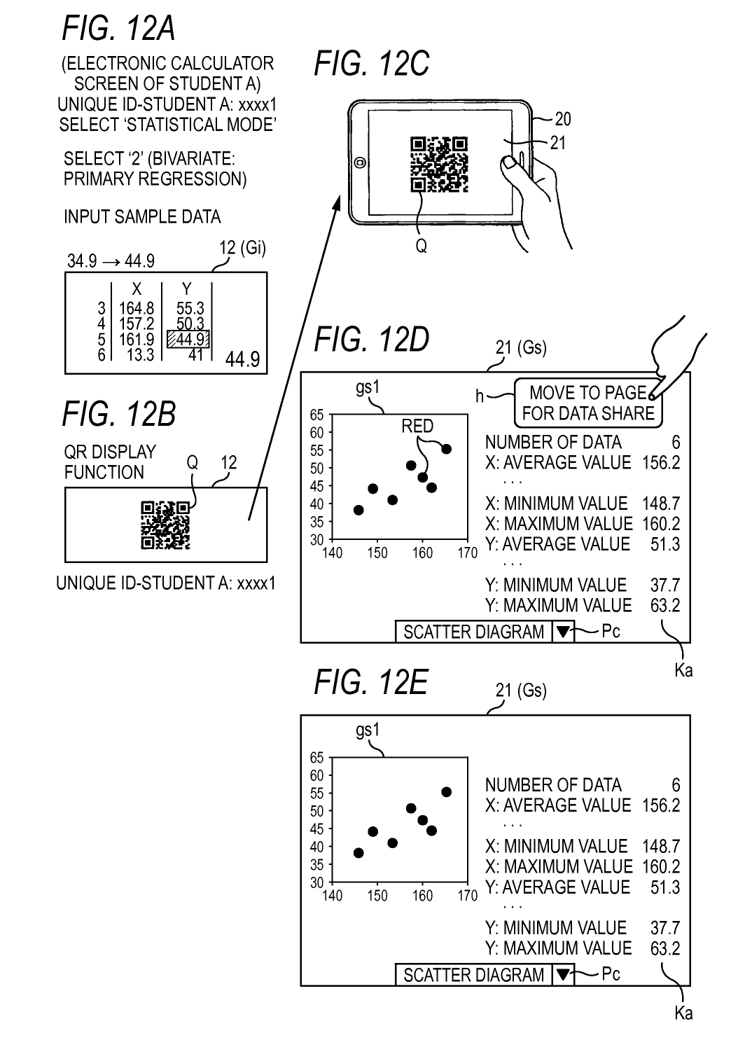

FIGS. 12A, 12B, 12C, 12D and 12E depict transition of display operations associated with re-input of the table data at the statistical mode of the scientific calculator 10A of the student A and display operations associated with the access of the communication device 20A of the student A to the compute server 30.

<Scientific Calculator A>

When [44.9] is input to the weight Y of the sample data [5] in the table data input screen Gi on the scientific calculator 10A of the student A so as to correct the table data shown in FIG. 8C, as shown in FIG. 12A, the corrected element data X, Y is stored in the input data area 143 of the memory 14 (steps S101 to S103).

Then, when the [QR] key is operated (step S104), a two-dimensional code image is generated and displayed on the display unit 12 (step S105).

<Communication Device>

At this time, like the above processing, when the student A captures the two-dimensional code image Q by the communication device 20A, as shown in FIG. 12C, the contents of the two-dimensional code image Q are decoded (step S201), and the barcode content data is transmitted to the homepage (HP) address of the compute server 30 (step S202).

<Server>

Like the above processing, the compute server 30 temporarily preserves the barcode content data received from the communication device 20A of the student A (steps S305, S306) and executes the statistical calculation in correspondence to the barcode content data. Thereby, the image data Gs (refer to FIG. 12D) of the calculation result including the corrected calculation result Ka and graph image (scatter diagram) gs1 is prepared and transmitted to the communication device 20A of the student A (steps S305 to S310).

<Communication Device>

When the communication device 20A receives the image data Gs of the calculation result and the icon h ‘move to page for data share’ transmitted from the compute server 30, the server homepage (HP) screen in which the icon h is incorporated in the image data Gs of the calculation result is displayed on the display unit 21, as shown in FIG. 12D (step S203).

Like the above processing, when the icon h ‘move to page for data share’ is touched on the server homepage (HP) screen (Gs) (step S204), the compute server 30 determines that the calculator-unique ID (xxxx1) included in the temporarily preserved barcode content data from the scientific calculator 10A has been registered (steps S311, S312 (Yes)). Therefore, the temporarily preserved barcode content data is overwritten and registered in the dedicated data area 322A (step S315).

Then, as shown in FIG. 12E, the image data Gs of the calculation result, which includes the calculation result Ka and the graph image (scatter diagram) gs1 based on the corrected computational element data (X, Y), is displayed as shown in FIG. 12E.

<Scientific Calculator C>

At this time, when the sample data of heights X/weights Y of German junior high school girls is input on the scientific calculator 10C (not shown) of the student C and the two-dimensional code image is displayed on the display unit 12 by the same operations, and the student C captures the two-dimensional code image Q by the communication device 20C, the compute server 30 associates the barcode content data with the calculator-unique ID (xxxx3) and registers the same in the dedicated data area 322A for the corresponding group ID.

<Communication Device>

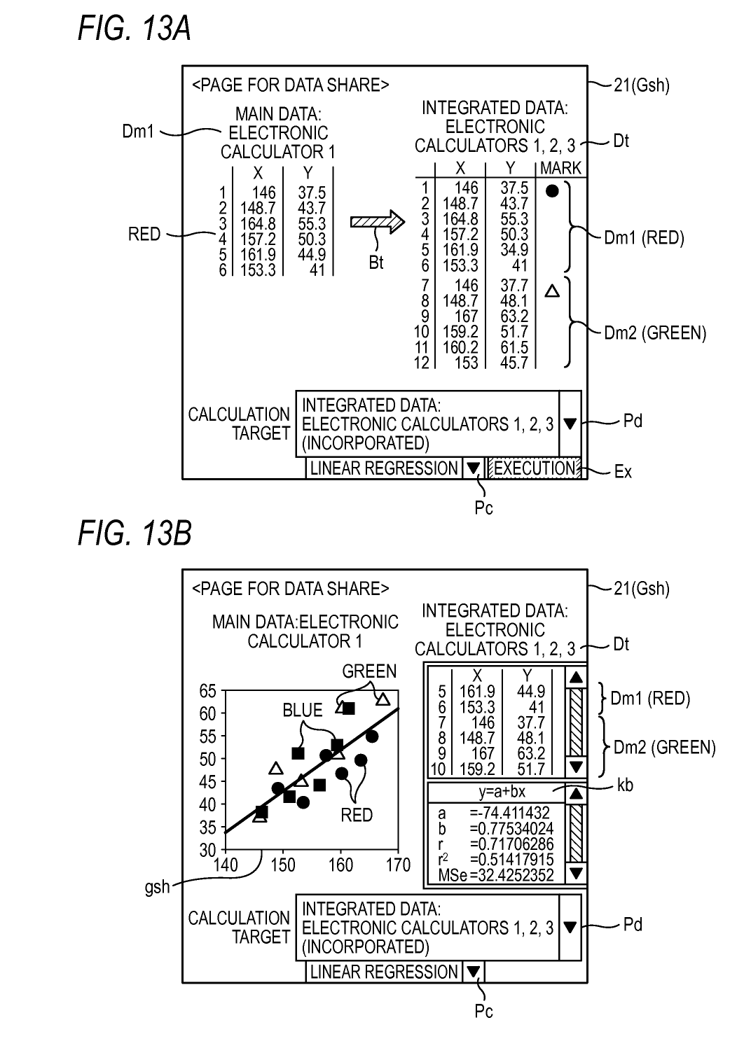

FIGS. 13A and 13B depict the display operations on the server homepage (HP) screen (at a state where the barcode content data from the three students A, B, C is preserved) of the communication device 20A of the student A.

As described above, the respective barcode content data is registered in the dedicated data area 322A corresponding to the same group ID ‘ABC123’ to which all the students A, B, C belong.

When the icon h ‘move to page for data share’ is touched on the server homepage (HP) screen (the image data Gs of the calculation result) (refer to FIG. 12D) displayed on the communication device 20A (step S204), the image data for data share Gsh (refer to FIG. 13A) having the integrated (aggregated) calculation target data Dt, in which the calculation target data Dm1 obtained from the scientific calculator 10A, the calculation target data Dm2 obtained from the scientific calculator 10B, and the calculation target data Dm3 obtained from the scientific calculator 10C are integrated, is prepared and transmitted to the communication device 20A of the student A (steps S311, S312 to S315, S316).

Also, the pull-down menu Pd and the pull-down menu Pc are transmitted to the communication device 20A (step S317).

In the integrated image data for data share Gsh, the calculation target data Dm1 is identified with the red numerical values and mark ‘’, the calculation target data Dm2 is identified with the green numerical values and mark ‘Δ’, and the calculation target data Dm3 is identified with the blue numerical values and mark ‘▪’.

When the communication device 20A receives the image data for data share Gsh transmitted from the compute server 30, the server homepage (HP) screen (Gsh), in which the pull-down menus Pd, Pc are added to the image data for data share Gsh, is displayed on the display unit 21 (step S205), as shown in FIG. 13A.

Here, the items ‘main data: calculator 1’, ‘integrated data: calculators 1, 2, 3 (incorporated)’ and ‘integrated data: calculators 1, 2, 3 (parallel)’ for designating the calculation target are set to be selectable in the pull-down menu Pd.

As shown in FIG. 13a, when the item ‘integrated data: calculators 1, 2, 3 (incorporated)’ is designated by the pull-down menu Pd, the item ‘linear regression’ is designated by the pull-down menu Pc and the [Execution] button Ex is touched, as shown in FIG. 13A, the designation contents (the calculation target ‘integrated data: calculator 1, 2, 3 (incorporated)’ and the calculation type ‘linear regression’) are transmitted to the compute server 30 (step S204).

In the compute server 30, the parameters a, b of the regression formula (y=a+bx), the correlation coefficient r and the like are calculated based on the integrated (aggregated) calculation target data (incorporated) Dt, in which the statistical calculation target data (X, Y) of Japanese, US and German junior high school girls registered with being associated with the calculator-unique IDs (xxxx1) to (xxxx3) is incorporated, and the integrated (aggregated) calculation target data Dt and the calculation result Kb are prepared and transmitted as aggregated calculation result data Dt of an aggregation calculation result. More specifically, the image data for data share Gsh (refer to FIG. 13B), which includes the aggregated calculation target data Dt, the image data in which the character data of the calculation result Kb is imaged, and the integrated graph image (linear regression) gs, is prepared and transmitted to the communication device 20A of the student A, as the server homepage (HP) screen (Gsh) (step S319).

Then, as shown in FIG. 13B, the received server homepage (HP) screen (Gsh) is displayed on the display unit 21 of the communication device 20A (step S205).

At this time, when an instruction to end the processing is transmitted to the compute server 30 by the user's operation on the communication device 20 (steps S206 (Yes), S207), the series of calculation server processing is over in the compute server 30 and the processing returns to the initial processing (step S320 (Yes) to S301).

In the meantime, when the [QR] key is operated on the scientific calculator 10 after the statistical calculation is executed, the two-dimensional code image Q including the statistical calculation result data is displayed. When the two-dimensional code is captured by the communication device 20 and the barcode content data is transmitted to the compute server 30, the compute server 30 determines that the statistical calculation result data is also included in the barcode content data (steps S307, S308 (No)).

Then, the statistical calculation is performed and the parameters a, b of the regression formula (y=a+bx), the correlation coefficient r and the like are calculated based on the barcode content data, and the graph image (linear regression) is prepared and transmitted to the communication device 20 (steps S321/S203).

Meanwhile, the calculation server processing (embodiment 1) depicted in FIG. 6, the communication device 20 of the teacher accesses the group ID registration site of the compute server 30, so that the dedicated data area 322 for the group ID is prepared in advance, as shown in FIG. 8A (steps S301 to S304).

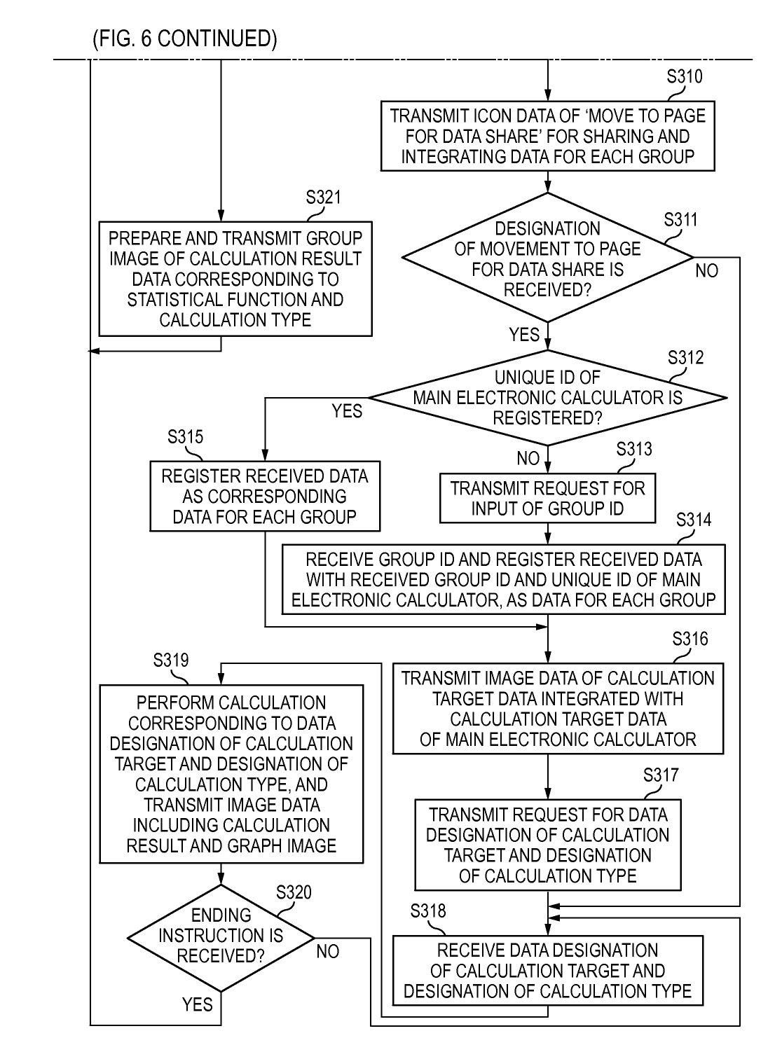

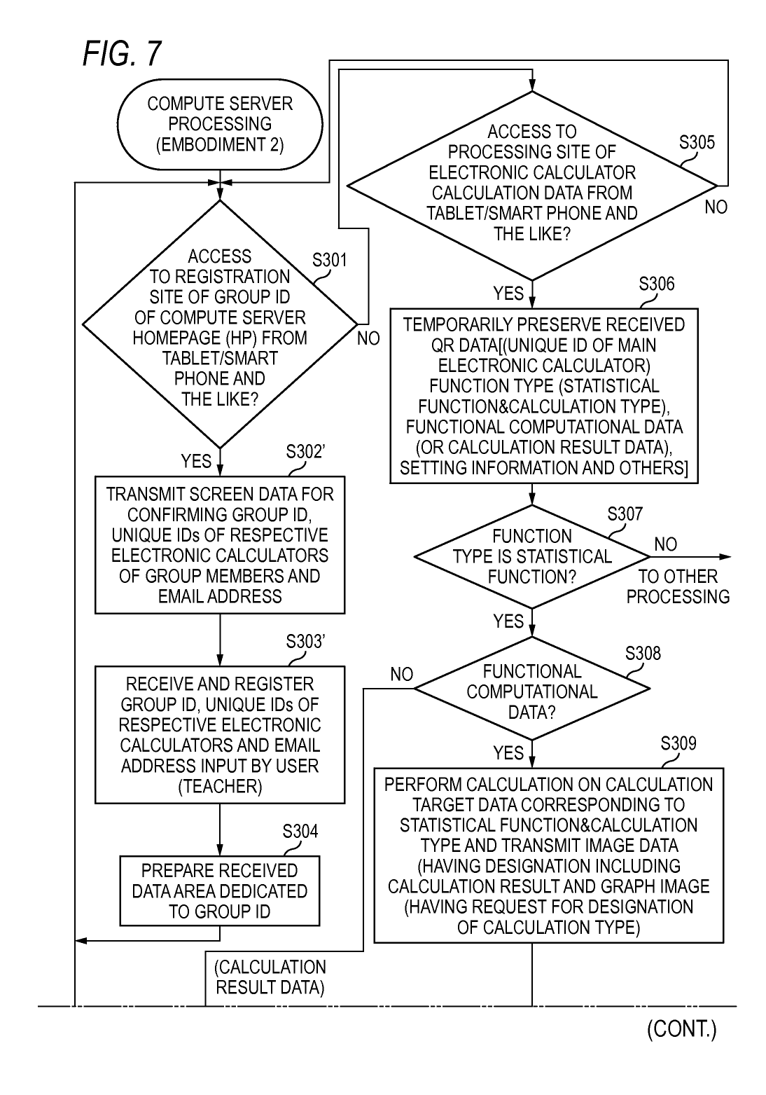

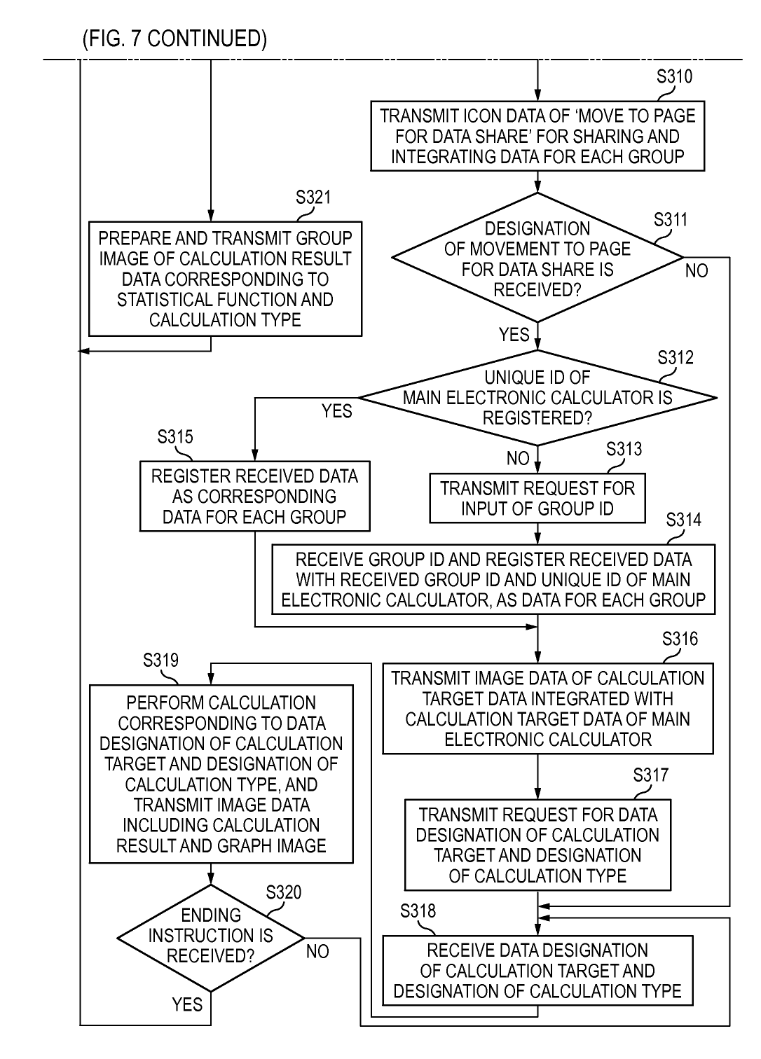

In contrast, as shown in the calculation server processing (embodiment 2) of FIG. 7, the corresponding calculator-unique ID may be registered in advance in the dedicated data area 322 for the group ID by registering in advance the group ID of the group that is handled by the teacher, the calculator-unique ID of each student belonging to the group and the email address of the communication device 20 of the teacher in the group ID memory 323 (steps S301, S302′, S303′,S304).

According to this configuration, when the barcode content data obtained from the scientific calculator 10 is received at the compute server 30, the dedicated data area 322A for the group ID corresponding to the calculator-unique ID included in the received data is automatically determined and data is registered therein (step S312 (Yes) to S315). For this reason, the processing (steps S314, S315) of requesting the respective users (the student A, B, . . . ) to input the group ID and determining the dedicated data area 322 for the group ID corresponding to the calculator-unique ID included in the received data is not required. Meanwhile, also in the calculation server processing (embodiment 2), when the calculator-unique ID included in the received data is not registered in any dedicated data area 322 for the group ID, the request for input of the group ID is transmitted to the user, the dedicated data area 322 for the input group ID is prepared and the calculator-unique ID is associated and set (step S312 (No) to S313, S314), like the embodiment 1.

In the above embodiments, the calculation data is aggregated for each group ID for the unique ID of the information display device (calculator) of each student at the server. In this case, when the calculation data is corrected with the same unique ID and is acquired at the server, the calculation data of the unique ID is updated and registered. In contrast, even with the same unique ID, the calculation data may be individually stored ad aggregated by date and time. Also, the latest calculation data of the unique ID of the data aggregated to the group ID may be aggregated as the aggregation target. Also, the teacher who manages the group ID may be enabled to initialize the aggregated data in the group ID and to set whether to delete the data except for the latest calculation data of each unique ID or to save all the data.

In the meantime, the methods of the respective processing by the data integration system described in the illustrative embodiments, i.e., the respective methods of the display control processing by the scientific calculator (information display device) depicted in the flowchart of FIG. 4, the communication device processing by the communication device 20 depicted in the flowchart of FIG. 5, the server processing (embodiment 1) by the compute server 30 depicted in the flowchart of FIG. 6, the server processing (embodiment 2) by the compute server 30 depicted in the flowchart of FIG. 7, and the like may be stored and distributed in the recording medium such as a memory card (a ROM card, a RAM card and the like), a magnetic disc (floppy (registered trademark) disc, hard disc and the like), an optical disc (a CD-ROM, a DVD and the like) and a semiconductor memory, as a program configured to be executable by a computer. Also, the program data for implementing the respective methods may be transmitted through the communication network N, as program codes, and the program data is received at a computer of an electronic device connected to the communication network N by a communication unit, so that the display control function, the communication device function and the server function can be implemented.

The disclosure is not limited to the illustrative embodiments and can be variously modified without departing from the scope and spirit of the disclosure upon the implementation. Further, the illustrative embodiments include a variety of inventions, and a variety of inventions can be conceived by an appropriate combination of the plurality of disclosed constitutional elements. For example, even when some of all the constitutional elements described in the illustrative embodiments are omitted and some constitutional elements are combined as other shapes, it is possible to solve the above-described problems. Also, the configuration where the constitutional elements are omitted or combined can be conceived as the invention when the above-described effects are accomplished.

What is claimed is:

1. A server apparatus comprising:
a processor configured to perform:
calculation target data receiving processing that receives calculation target data which is to be output from an information display device;
group ID receiving processing that receives a group ID;
data registering processing that registers the calculation target data received in the calculation target data receiving processing in association with the group ID received in the group ID receiving processing; and
integrated calculation result transmitting processing that integrates each calculation target data registered in association with the group ID in the data registering processing for each group ID and that transmits a calculating result based on the integrated data.

2. The server apparatus according to claim 1,
wherein the integrated calculation result transmitting processing includes integrated image transmitting processing that integrates each calculation target data registered in association with the group ID in the data registering processing for each group ID to generate integrated image data and that transmits the integrated image data.

3. The server apparatus according to claim 2,
wherein the calculation target data receiving processing receives the calculation target data output from the information display device, together with a unique ID of the information display device, and
wherein the data registering processing registers the calculation target data received in the calculation target data receiving processing in association with the group ID and with the unique ID of the information display device.

4. The server apparatus according to claim 3,
wherein the data registering processing registers the received calculation target data in association with the group ID having the unique ID registered therein when the unique ID of the information display device received in the calculation target data receiving processing is registered in association with the group ID.

5. The server apparatus according to claim 2,
wherein the processor is further configured to perform:
integration confirmation request transmitting processing that adds a confirmation request to image data corresponding to the calculation target data and that transmits the image data with the confirmation request, when the calculation target data is received in the calculation target data receiving processing,
wherein the confirmation request indicates whether to integrate each calculation target data, and
wherein the integrated image transmitting processing transmits the integrated image data in which each calculation target data registered in the data registering processing is integrated for each group ID, when a response indicating each calculation target data is to be integrated is received.

6. The server apparatus according to claim 5,
wherein the processor is further configured to perform:
integration designation request transmitting processing that transmits a designation request as to whether to integrate each calculation target data to be merged or to be in parallel, when the response indicating the calculation target data is to be integrated is received in accordance with the confirmation request transmitted in the integration confirmation request transmitting processing, and
wherein the integrated image transmitting processing transmits the integrated image data in which each calculation target data is integrated to be merged for each group ID when the response indicating each calculation target data is to be integrated and merged is received, and
wherein the integrated image transmitting processing transmits the integrated image data in which each calculation target data is integrated in parallel for each group ID when the response indicating each calculation target data is to be integrated in parallel.

7. The server apparatus according to claim 2,
wherein the calculation target data output from the information display device is displayed on the information display device as a two-dimensional code image,
wherein the calculation target data receiving processing receives content data from a communication device which is configured to read the displayed two-dimensional code image and which is configured to transmit the content data of the read two-dimensional code image, and
wherein the group ID receiving processing receives a group ID which is input by a user's operation on the communication device, from the communication device.

8. The server apparatus according to claim 7,
wherein the integrated image transmitting processing transmits the integrated image data integrated for each group ID to the communication device which transmits the content data of the two-dimensional code image.

9. A server apparatus comprising:
a processor configured to perform:
group ID registering processing that registers a group ID in association with a unique ID of an information display device belonging to the group ID;
calculation target data receiving processing that receives the unique ID and calculation target data from the information display device;
data registering processing that registers the calculation target data received in the calculation target data receiving processing in association with the group ID of the information display device registered in the group ID receiving processing, in accordance with the received unique ID; and
integrated calculation result transmitting processing that integrates each calculation target data registered in association with the group ID in the data registering processing for each group ID and that transmits a calculating result based on the integrated data.

10. The server apparatus according to claim 9,
wherein the data registering processing registers the received calculation target data in association with a group ID which is newly input by a user's operation, when the unique ID of the information display device received together with the calculation target data in the calculation target data receiving processing is not registered with the group ID registered in the group ID registering processing.

11. A data integration method of a server apparatus, the data integration method comprising:
a calculation target data receiving step of receiving calculation target data which is to be output from an information display device;
a group ID receiving step of receiving a group ID;
a data registering step of registering the calculation target data received in the calculation target data receiving step in association with the group ID received in the group ID receiving step, and
an integrated calculation result transmitting step of integrating each calculation target data registered in association with the group ID in the data registering step for each group ID and of transmitting a calculating result based on the integrated data.

12. The data integration method according to claim 11,
wherein the integrated calculation result transmitting step includes an integrated image transmitting step of integrating each calculation target data registered in association with the group ID in the data registering step to generate integrated image data and of transmitting the integrated image data.

13. The data integration method according to claim 12,
wherein the calculation target data receiving step receives the calculation target data output from the information display device, together with a unique ID of the information display device, and
wherein the data registering step registers the calculation target data received in the calculation target data receiving step in association with the group ID and with the unique ID of the information display device.

14. The data integration method according to claim 13,
wherein the data registering step registers the received calculation target data in association with the group ID having the unique ID registered therein when the unique ID of the information display device received in the calculation target data receiving step is registered in association with the group ID.

15. The data integration method to claim 12, further comprising:
an integration confirmation request transmitting step of adding a confirmation request to image data corresponding to the calculation target data and of transmitting the image data with the confirmation request, when the calculation target data is received in the calculation target data receiving step, and
wherein the confirmation request indicates whether to integrate each calculation target data, and
wherein the integrated image transmitting step transmits the integrated image data in which each calculation target data registered in the data registering step is integrated for each group ID, when a response indicating each calculation target data is to be integrated is received.

16. The data integration method according to claim 15, further comprising:
an integration designation request transmitting step of transmitting a designation request as to whether to integrate each calculation target data to be merged or to be in parallel, when the response indicating the calculation target data is to be integrated is received in accordance with the confirmation request transmitted in the integration confirmation request transmitting step, and
wherein the integrated image transmitting step transmits the integrated image data in which each calculation target data is integrated to be merged for each group ID when the response indicating each calculation target data is to be integrated and merged is received, and
wherein the integrated image transmitting step transmits the integrated image data in which each calculation target data is integrated in parallel for each group ID when the response indicating each calculation target data is to be integrated in parallel.

17. The server apparatus according to claim 12,
wherein the calculation target data output from the information display device is displayed on the information display device as a two-dimensional code image,
wherein the calculation target data receiving step receives content data from a communication device which is configured to read the displayed two-dimensional code image and which is configured to transmit the content data of the read two-dimensional code image, and
wherein the group ID receiving step receives a group ID which is input by a user's operation on the communication device, from the communication device.

18. The server apparatus according to claim 17,
wherein the integrated image transmitting step transmits the integrated image data integrated for each group ID to the communication device which transmits the content data of the two-dimensional code image.

19. An electronic device configured to communicate with a server apparatus, the server apparatus comprising a processor configured to perform: calculation target data receiving processing that receives calculation target data which is to be output from an information display device; group ID receiving processing that receives a group ID; data registering processing that registers the calculation target data received in the calculation target data receiving processing in association with the group ID received in the group ID receiving processing; and integrated calculation result transmitting processing that integrates each calculation target data registered in association with the group ID in the data registering processing for each group ID and that transmits a calculating result based on the integrated data, the electronic device comprising a processor configured to perform:
data acquisition processing that acquires the calculation target data from the information display device;
input processing that enables a user to input the group ID; and
transmission processing that transmits the calculation target data and the group ID to the server apparatus.
